(19) United States
(12) Patent Application Publication
(10) Pub. No.: US 2009/0049340 A1
(43) Pub. Date: Feb. 19, 2009

(54) System analysis device and computer readable storage medium storing system analysis program

(75) Inventors: Yunichi Yada, Saitama (JP); Tomoya Hitokoto, Saitama (JP); Akiyoshi Shimmura, Saitama (JP); Kazutaka Oki, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/155,636

(22) Filed: Jun. 6, 2008

(30) Foreign Application Priority Data
Aug. 15, 2007 (JP) 2007-211801

(51) Int. Cl. G06F 11/28

(52) U.S. Cl. 714/37; 714/E11.178

(57) ABSTRACT

A system analysis device for analyzing a state of operation of a computer system includes an analysis processing section, an analysis program storage section, a diagnostic processing section and a condition definition information storage section. The analysis processing section analyzes analysis subject data outputted from the analysis subject computer system. The analysis program storage section stores plural analysis programs, which perform analysis processing on the analysis subject data. The diagnostic processing section diagnoses a state of operation of the computer system from analysis results. The condition definition information storage section stores condition definition information, which defines conditions to be determination standards of the diagnostic processing. The analysis programs and the condition definition information are updated respectively separately from one another.

### CROSS-REFERENCE TO RELATED APPLICATION

This application claims priority under 35 USC 119 from Japanese Patent Application No. 2007-211801, the disclosure of which is incorporated by reference herein.

### BACKGROUND OF THE INVENTION

1. Field of the Invention

The present invention relates to a system analysis device and a computer-readable storage medium storing a system analysis program, and more particularly to a system analysis device and a computer-readable storage medium storing a system analysis program for analyzing a state of operation of a computer system.

2. Description of the Related Art

When an administrator of a computer system checks a state of operation of the system or investigates an occurrence of a malfunction or the like, ordinarily, numerical values and data are obtained from system settings information, log files and the like, it is determined whether or not the data is normal, and a state of the system is judged. Processes have been proposed for performing such work automatically with a program. For example, Japanese Patent Application Laid-Open (JP-A) No. 2005-266919 has disclosed a system analysis device which automatically collects system structure information, log files and the like and analyzes the information in accordance with pre-specified judgment standards.

Such a system (below referred to as an analysis system) for analyzing a state of a computer system has previously implemented, in the same program, a section that performs processing for determining whether or not data of an analysis subject system is normal (below referred to as a logic section) and a section that defines determination conditions of data for performing the determination processing (below referred to as a knowledge section).

However, in such an analysis system, there are many changes, adding new determination conditions and altering previously specified determination conditions, in accordance with previous analysis results, new discoveries of malfunctions and the like. Therefore, if the logic section and the knowledge section are implemented in the same program as in a conventional analysis system, then when determination conditions of the knowledge section are added, deleted or the like, it is necessary to apply changes to the whole program, and it is difficult to apply changes to the knowledge section without manipulating the program of the logic section. Moreover, each time the knowledge section is changed, a lot of work is generated in repetition of complete program testing and the like.

### SUMMARY OF THE INVENTION

The present invention has been made in view of the above circumstances and provides a system analysis device and a computer-readable storage medium storing a system analysis program.

According to a first aspect of the invention, there is provided a system analysis device for analyzing a state of operation of a predetermined computer system, the system analysis device comprising: an analysis processing section that analyzes analysis subject data outputted from a computer system; an analysis program storage section that stores a plurality of analysis programs, which are executed by the analysis processing section and perform analysis processing on the analysis subject data; a diagnostic processing section that diagnoses a state of operation of the computer system from analysis results according to the analysis processing section; and a condition definition information storage section that stores condition definition information, which defines conditions which are determination standards of diagnostic processing at the diagnostic processing section, wherein the analysis programs stored at the analysis program storage section and the condition definition information stored at the condition definition information storage section are updated respectively separately from one another.

According to a second aspect of the invention, there is provided a computer readable medium storing a program causing a computer to execute a process for analyzing a state of operation of a predetermined computer system, the process comprising: analyzing analysis subject data outputted from an analysis subject computer system; diagnosing a state of operation of the computer system from analysis results; storing a plurality of analysis programs, which perform analysis processing on the analysis subject data; storing condition definition information, which defines conditions which are determination standards of diagnostic processing; and updating the analysis programs and the condition definition information respectively separately from one another.

### BRIEF DESCRIPTION OF THE DRAWINGS

Preferred embodiments of the present invention will be described in detail based on the following figures, wherein:

FIG. 1 is a block diagram showing schematic structure of a system analysis device relating to an exemplary embodiment of the present invention.

FIG. 2 is a flowchart showing a flow of plug-in setting processing which is executed by the system analysis device relating to the same exemplary embodiment.

FIG. 3 is a flowchart showing a flow of system analysis processing which is executed by the system analysis device relating to the same exemplary embodiment.

### DETAILED DESCRIPTION OF THE INVENTION

Herebelow, an exemplary embodiment of the present invention will be described with reference to the attached drawings. In this specification and the drawings, structural elements that have substantially the same functional structure are assigned the same reference numerals, and duplicative descriptions will not be given.

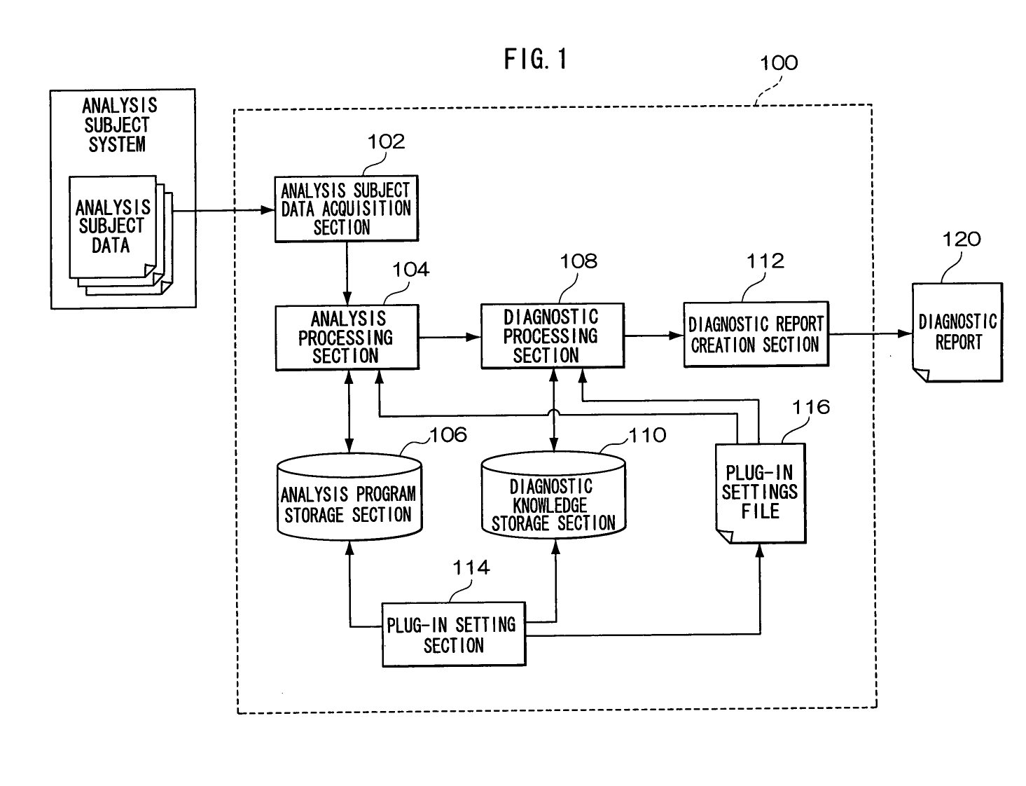

First, a system analysis device relating to the exemplary embodiment of the present invention will be described with reference to FIG. 1. FIG. 1 is a block diagram showing schematic structure of a system analysis device 100 relating to the exemplary embodiment of the present invention.

The system analysis device 100 relating to the present exemplary embodiment is a system for analyzing settings information, log information and the like provided from a computer system which is a subject of analysis (below referred to as the analysis subject system), performing an analysis for determining a state of operation of the system, and providing analysis information which can be used in maintenance work of the computer system. Herein, maintenance work of the computer system means work for new construction of the computer system, changes of structure and settings, periodic diagnostics, investigating and recovering from occurrences of malfunctions, and the like.

As shown in FIG. 1, the system analysis device 100 relating to the present exemplary embodiment is structured with an analysis subject data acquisition section 102, an analysis processing section 104, an analysis program storage section 106, a diagnostic processing section 108, a diagnostic knowledge storage section 110, a diagnostic report creation section 112, and a plug-in setting section 114. Below, the sections structuring the system analysis device 100 will each be described.

Analysis Subject Data Acquisition Section 102

The analysis subject data acquisition section 102 is a functional section for acquiring settings information, resource information, log information and the like which are outputted from the analysis subject computer system, data which is an analysis subject for identifying a state of the system (below referred to as analysis subject data). The analysis subject data acquisition section 102 may acquire the analysis subject data periodically at a pre-specified time interval, and may acquire the analysis subject data continuously from the analysis subject system in accordance with control by a person responsible for analysis or the like. The acquired data is accumulated in a memory device (not shown) and inputted to the analysis processing section 104.

Analysis Processing Section 104

The analysis processing section 104 is a functional section for analyzing the analysis subject data and determining whether or not a state of the analysis subject system is normal. From the contents of the analysis subject data, the analysis processing section 104 analyzes a resource use situation, a settings state, an operation situation and suchlike of the analysis subject system, and inputs analysis results to the diagnostic processing section 108. Each analysis process is performed by executing a plug-in program for analysis processing, which is stored in the analysis program storage section 106. The analysis processing section 104 may select and execute one or a plurality of programs from plural programs which are stored in the analysis program storage section 106, on the basis of pre-specified values from a plug-in settings file 116 created by the plug-in setting section 114, input values from a user running the analysis, or the like. Alternatively, the analysis processing section 104 may select (an) analysis program(s) in accordance with a category of the analysis subject system, a category of the analysis subject data or the like.

Analysis Program Storage Section 106

The analysis program storage section 106 is a memory section for storing plug-in programs for executing the analysis processing which is performed at the analysis processing section 104. Each plug-in program stored in the analysis program storage section 106 is stored at a predetermined location within the analysis program storage section 106 by the plug-in setting section 114, and is executed by a call instruction from the analysis processing section 104. Each plug-in program may be executed respectively independently or may be structured such that one program will call another program. Each plug-in program may execute analysis processing corresponding to a respective predetermined analysis subject system, or may execute standard analysis processing that corresponds to analysis items which are common to a plurality of analysis subject systems.

Diagnostic Processing Section 108

The diagnostic processing section 108 is a functional section for receiving results of the analysis processing executed by the analysis processing section 104, and performing diagnostics on whether an irregularity has arisen in the analysis subject system, whether there is an error in specified values or the like, and a condition of operation. After the diagnostic processing, the diagnostic processing section 108 inputs diagnostics results to the diagnostic report creation section 112.

For example, from results of diagnosis of a resource usage state of the system by the analysis processing section 104, if a rate of use of memory is below a predetermined proportion, the diagnostic processing section 108 diagnoses a shortage of resources. Alternatively, the diagnostic processing section 108 diagnoses, from a rate of use of a CPU or the like that is found by the analysis processing section 104, that the system is running out of control if this rate of use is above a predetermined proportion.

This diagnosis processing at the diagnostic processing section 108 is performed using diagnostic knowledge stored in the diagnostic knowledge storage section 110. The diagnostic knowledge defines judgment conditions for judging from respective analysis results whether an operation state of the analysis subject system is normal or irregular. The diagnostic processing section 108 may select one or a plural sets of diagnostic knowledge from plural sets of knowledge which are stored in the diagnostic knowledge storage section 110, on the basis of pre-specified values from the plug-in settings file 116 created by the plug-in setting section 114, input values from a user running the analysis, or the like. Alternatively, the diagnostic processing section 108 may select (a) set(s) of analysis knowledge in accordance with a category of the analysis subject system, a category of the analysis subject data or the like.

Diagnostic Knowledge Storage Section 110

The diagnostic knowledge storage section 110 is a functional section for storing the diagnostic knowledge to be used in the diagnostic processing performed by the diagnostic processing section 108. The diagnostic knowledge defines judgment conditions for judging whether an operation state of the analysis subject system is normal or irregular from respective analysis results, as described above. The diagnostic knowledge defines, for example, values which are thresholds for judging irregularities of the system from analysis results such as a rate of use of memory, categories of errors to be judged from these values, and the like. Herein, the diagnostic knowledge is an example of condition definition information for the present exemplary embodiment, and the diagnostic knowledge storage section 110 is an example of a condition definition information storage section.

Diagnostic Report Creation Section 112

The diagnostic report creation section 112 is a functional section for creating a diagnostic report 120, from results of diagnosis of the system by the diagnostic processing section 108. The diagnostic report creation section 112 receives diagnostics results from the diagnostic processing section 108 and creates the diagnostic report 120, which describes analysis subject data which are basis of the diagnostics results, diagnostics results from this data and the like. The diagnostic report 120 that has been created is sent through a network to an external device, or is outputted, such as by printing onto a paper medium, by an output device such as a printer or the like.

Plug-In Setting Section 114

The plug-in setting section 114 is a functional section for adding an analysis program, set of diagnostic knowledge or the like that has been inputted to the system analysis device 100 by a user, or updating or deleting an analysis program, set of diagnostic knowledge or the like which has been previously stored. Herein, the plug-in setting section 114 relating to the present exemplary embodiment is an example of an analysis program setting section and a condition definition information setting section of the present invention.

The plug-in setting section 114 stores an analysis program inputted by the user in the analysis program storage section 106 and registers a reference location thereof in the plug-in settings file 116. Alternatively, if an inputted analysis program is an updated version of an analysis program that was previously stored in the analysis program storage section 106, the plug-in setting section 114 reads the reference location of this analysis program from the plug-in settings file 116 and stores the inputted analysis program at the corresponding location in the analysis program storage section 106. Further, if a selected analysis program is to be deleted from the analysis program storage section 106, the plug-in setting section 114 reads the reference location of this analysis program from the plug-in settings file 116 and deletes the analysis program stored at the corresponding location in the analysis program storage section 106. The plug-in setting section 114 then deletes registration details relating to the deleted analysis program from the plug-in settings file 116.

The plug-in setting section 114 performs update processing for sets of diagnostic knowledge stored in the diagnostic knowledge storage section 110 by similar processing to that described above for analysis programs. Herein, although the present exemplary embodiment has been described with update processing for both analysis programs and diagnostic knowledge being performed by the plug-in setting section 114, a functional section for implementing updates of analysis programs and a functional section for implementing updates of diagnostic knowledge may be provided respectively separately.

The plug-in setting section 114 also registers in the plug-in settings file 116, besides reference locations of analysis programs and sets of diagnostic knowledge, information to serve as selection standards for when the analysis processing section 104 or diagnostic processing section 108 is selecting an analysis program or set of diagnostic knowledge, such as when selecting which analysis program(s) and/or set(s) of diagnostic knowledge to use for which analysis subject data and/or analysis subject system, which set(s) of diagnostic knowledge to use in correspondence with an analysis program that is being employed, or the like.

Hereabove, structure of the system analysis device 100 has been described. Herein, the analysis subject data acquisition section 102, the analysis processing section 104, the diagnostic processing section 108, the diagnostic report creation section 112 and the plug-in setting section 114 may be realized by installing a software program which executes the functions of the respective sections in the system analysis device 100, and may be realized with dedicated hardware. The above-mentioned software program may be memorized at a computer-readable storage medium and executed by being read therefrom, or may be provided to the system analysis device 100 through a network or the like. The analysis program storage section 106 and the diagnostic knowledge storage section 110 may be structured by various memory media and the like such as, for example, semiconductor memory, optical disks, magnetic disks and the like.

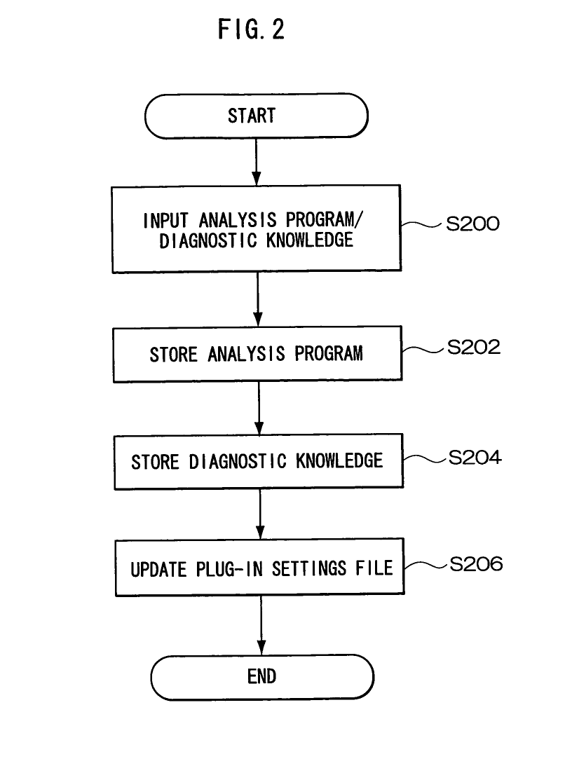

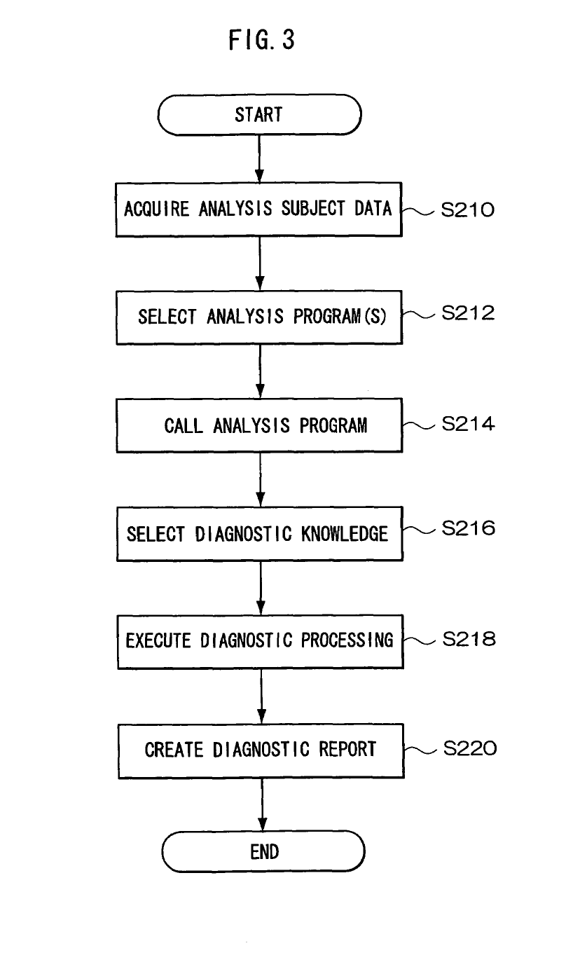

Next, operation of the system analysis device 100 will be described with reference to FIG. 2 and FIG. 3. FIG. 2 is a flowchart showing a flow of plug-in setting processing which is executed by the system analysis device 100. FIG. 3 is a flowchart showing a flow of system analysis processing which is executed by the system analysis device 100. First, processing for specifying beforehand an analysis plug-in program and set of diagnostic knowledge for performing analysis of an analysis subject system will be described with reference to FIG. 2. Then, system analysis processing that uses the specified analysis plug-in program and set of diagnostic knowledge will be described.

The plug-in setting processing that is executed by the system analysis device 100 will be described with reference to FIG. 2. Here, processing which adds a new analysis program and set of diagnostic knowledge to the system analysis device 100 will be described.

First, a person registering each plug-in prepares an analysis program and set of diagnostic knowledge required for analysis of a predetermined analysis subject system, and inputs the same into the system analysis device 100 (step S200). Here, an example of a case in which the analysis program and diagnostic knowledge are inputted at the same time will be described, but an analysis program may be separate, and separately inputted, from diagnostic knowledge.

Next, the plug-in setting section 114 of the system analysis device 100 stores the inputted analysis program at a location in the analysis program storage section 106 to which the analysis processing section 104 will be able to refer (step S202). Similarly, the plug-in setting section 114 stores the inputted diagnostic knowledge at a location in the diagnostic knowledge storage section 110 to which the diagnostic processing section 108 will be able to refer (step S204).

Then, the plug-in setting section 114 registers the reference location of the analysis program and the reference location of the set of diagnostic knowledge, adding these to the plug-in settings file 116 (step S206). Hence, by referring to the plug-in settings file 116, the analysis processing section 104 and the diagnostic processing section 108 can call the added analysis program and diagnostic knowledge.

FIG. 2 shows an example of processing which adds newly prepared analysis programs and diagnostic knowledge, but it is also possible to update or delete analysis programs and sets of diagnostic knowledge which have been previously registered. For example, if a previously registered analysis program or set of diagnostic knowledge is to be updated, the plug-in setting section 114 first confirms the reference location of the analysis program or set of diagnostic knowledge to be updated, from the details registered in the plug-in settings file 116. Then, the plug-in setting section 114 overwrites the corresponding reference location in the analysis program storage section 106 or diagnostic knowledge storage section 110 with the updated analysis program or set of diagnostic knowledge.

Alternatively, if a previously registered analysis program or set of diagnostic knowledge is to be deleted, the plug-in setting section 114 first confirms the reference location of the analysis program or set of diagnostic knowledge to be deleted, from the plug-in settings file 116, and deletes the analysis program or set of diagnostic knowledge stored at this reference location. Then, the plug-in setting section 114 deletes information relating to the analysis program or set of diagnostic knowledge from the plug-in settings file 116.

Now, the system analysis processing that is executed by the system analysis device 100 will be described with reference to FIG. 3.

First, the analysis subject data acquisition section 102 of the system analysis device 100 acquires analysis subject data outputted from the analysis subject system and inputs the same into the analysis processing section 104 (step S210). Then, the analysis processing section 104 refers to the plug-in settings file 116 and selects one or a plurality of programs from the analysis programs stored in the analysis program storage section 106 (step S212). Then, the analysis processing section 104 calls and executes the selected analysis program(s), and executes analysis processing on the analysis subject data (step S214).

Next, the diagnostic processing section 108 receives analysis results for the analysis subject data from the analysis processing section 104, refers to the plug-in settings file 116, and selects one or a plurality of sets of diagnostic knowledge from the diagnostic knowledge stored in the diagnostic knowledge storage section 110 (step S216). Then, the diagnostic processing section 108 performs diagnostics on the analysis results using the selected set(s) of diagnostic knowledge, and judges a state of operation of the analysis subject system (step S218).

Lastly, the diagnostic report creation section 112 receives diagnostics results from the diagnostic processing section 108, and creates and outputs the diagnostic report 120 (step S220).

Thus, analysis programs, which are to execute analyses, and sets of diagnostic knowledge, which are to diagnose states of operation of a system from analysis results, are stored separately, and therefore updates, additions and deletions of both analysis programs and sets of diagnostic knowledge can be performed separately from one another. Therefore, even a person who does not know the details of analysis programs can apply changes such as additions of new conditions, deletions and the like to the diagnostic knowledge. Moreover, even if a new analysis program or set of diagnostic knowledge is added or previous contents are changed, it is not necessary to repeat complete testing, and time and costs relating to updates of programs can be reduced.

Hereabove, a preferred exemplary embodiment of the present invention has been described with reference to the attached drawings, but the present invention will obviously not be limited to this example. It will be apparent to a person skilled in the art that many modifications and improvements are possible within the scope recited in the claims, and obviously it is to be understood that these will fall within the technological scope of the present invention.

What is claimed is:

1. A system analysis device for analyzing a state of operation of a predetermined computer system, the system analysis device comprising:
an analysis processing section that analyzes analysis subject data outputted from a computer system;
an analysis program storage section that stores a plurality of analysis programs, which are executed by the analysis processing section and perform analysis processing on the analysis subject data;
a diagnostic processing section that diagnoses a state of operation of the computer system from analysis results according to the analysis processing section; and
a condition definition information storage section that stores condition definition information, which defines conditions which are determination standards of diagnostic processing at the diagnostic processing section,
wherein the analysis programs stored at the analysis program storage section and the condition definition information stored at the condition definition information storage section are updated respectively separately from one another.

2. The system analysis device of claim 1, wherein the analysis processing section selects at least one of the plurality of analysis programs to be executed, on the basis of a value inputted from outside the device.

3. The system analysis device of claim 1, wherein the analysis processing section selects at least one of the analysis programs to be executed, in accordance with a category of the analysis subject computer system.

4. The system analysis device of claim 1, wherein the analysis processing section selects at least one of the analysis programs to be executed, in accordance with a category of the analysis subject data.

5. The system analysis device of claim 1, wherein the diagnostic processing section selects the condition definition information that is to be used in the diagnostic processing, on the basis of a value inputted from outside the device.

6. The system analysis device of claim 1, wherein the diagnostic processing section selects the condition definition information that is to be used in the diagnostic processing, in accordance with a category of the analysis subject computer system.

7. The system analysis device of claim 1, wherein the diagnostic processing section selects the condition definition information that is to be used in the diagnostic processing, in accordance with a category of the analysis subject data.

8. The system analysis device of claim 1, further comprising an analysis program setting section that stores the analysis programs that are inputted from outside the device at the analysis program storage section and provides information for enabling execution of the analysis programs by the analysis processing section to the analysis processing section,
wherein the analysis processing section selects and executes the analysis programs on the basis of information provided by the analysis program setting section.

9. The system analysis device of claim 1, further comprising a condition definition information setting section that stores the condition definition information that is inputted from outside the device at the condition definition information storage section and provides information relating to the stored condition definition information to the diagnostic processing section,
wherein the diagnostic processing section selects the condition definition information and uses the condition definition information in diagnostic processing on the basis of information provided by the condition definition information setting section.

10. A computer readable medium storing a program causing a computer to execute a process for analyzing a state of operation of a predetermined computer system, the process comprising:
analyzing analysis subject data outputted from an analysis subject computer system;
diagnosing a state of operation of the computer system from analysis results;
storing a plurality of analysis programs, which perform analysis processing on the analysis subject data;
storing condition definition information, which defines conditions which are determination standards of diagnostic processing; and
updating the analysis programs and the condition definition information respectively separately from one another.
